(19) United States
(12) Patent Application Publication
(10) Pub. No.: US 2020/0060324 A1
(43) Pub. Date: Feb. 27, 2020

(54) FORMULATION AND METHOD FOR PREVENTING URINARY TRACT INFECTIONS

(71) Applicant: Jonathan T. Truong, Valencia, CA (US)

(72) Inventor: Jonathan T. Truong, Valencia, CA (US)

(21) Appl. No.: 16/548,617

(22) Filed: Aug. 22, 2019

Related U.S. Application Data
(60) Provisional application No. 62/721,515, filed on Aug. 22, 2018.

(51) Int. Cl. A23L 33/15; A23L 33/105; A23L 33/125

(52) U.S. Cl. CPC A23L 33/15; A23L 33/125; A23L 33/105

(57) ABSTRACT

A prophylaxis for preventing or reducing the occurrence of urinary tract infections in humans includes a formulation of vitamin C, D-mannose, cranberry extract, and pineapple extract. In a preferred embodiment, the formulation includes about 750 mg vitamin C, about 2000 mg D-mannose powder, about 1000 mg cranberry extract, and about 1000 mg pineapple extract. Additives, such as preservatives, binding materials, dyes, flavoring agents, and other excipients may also be present. A method of preventing or reducing the occurrence of urinary tract infections in a human involves administering vitamin C, D-mannose, cranberry extract, and pineapple extract to the human in a solid, dry dosage form on a daily basis.

### TECHNICAL FIELD

The present disclosure relates in general to dietary supplements and in particular to an oral supplement for preventing or reducing the occurrence of urinary tract infections.

### BACKGROUND

Patients with frequent urinary tract infections (UTIs) suffer from burning, pain, frequent visits to the rest room, and urine malodor. These infections are easily treated with short 3-day courses of antibiotics, which requires a prescription. A subset of patients suffers from recurrent urinary tract infections, defined as two infections within a 6 month period or three infections within a year. These patients are often prescribed longer courses of antibiotics, but reinfection often occurs, for a variety of reasons. Sometimes the cause cannot be fixed, and patients are prescribed medications to suppress infections.

The most common way to suppress recurrent infections is to prescribe mandelamine, which is available under the brand name Hiprex® from Validus Pharmaceuticals, LLC. This drug lowers the urine pH, making it difficult for bacteria to grow and multiply. Patients taking mandelamine are able to reduce the episodes of UTIs, but cannot suppress UTIs entirely as breakthrough infections do occur.

Patients may take over-the-counter phenazopyridine products, which are sold under various brand names including Azo®, Pyridium®, Uricalm®, and Uristat®, to reduce bladder pain. These preparations contain Phenazopyridine Hydrochloride, and produce an analgesic effect of the bladder and urinary tract. Some patients seek a more natural alternative, and try to drink large quantities of cranberry juice, which is known to be bacteriostatic in the urine. However, the efficacy of cranberry juice is mixed, and varies according to strength and concentration of cranberry product. There is still a need for more reliable way to suppress bacterial growth.

Other natural products that have been observed to reduce UTIs are ascorbic acid (vitamin C), D-mannose powder, and pineapple extract. To the best of our knowledge, these products have not been used in combination with one another.

### SUMMARY

A prophylactic for reducing or preventing the occurrence of urinary tract infections comprises a formulation of vitamin C, D-mannose, cranberry extract, and pineapple extract. In a preferred embodiment, the formulation comprises about 750 mg vitamin C, about 2000 mg D-mannose powder, about 1000 mg cranberry extract, and about 1000 mg pineapple extract. Preferably, the formulation is orally administered in a dry dosage form once or twice per day.

### DETAILED DESCRIPTION

As required, detailed embodiments of the present invention are disclosed herein; however, it is to be understood that the disclosed embodiments are merely exemplary of the invention that may be embodied in various and alternative forms. Therefore, specific functional details disclosed herein are not to be interpreted as limiting, but merely as a representative basis for teaching one skilled in the art to variously employ the present invention.

A natural homeopathic preparation for preventing or reducing the occurrence of urinary tract infections in humans comprises a formulation of vitamin C, D-mannose, cranberry extract, and pineapple extract. In a preferred embodiment, the formulation comprises about 750 mg vitamin C, about 2000 mg D-mannose powder, about 1000 mg cranberry extract, and about 1000 mg pineapple extract. Additives, such as preservatives, binding materials, dyes, flavoring agents, and other excipients may also be present.

The vitamin C, D-mannose, cranberry extract, and pineapple extract are preferably initially obtained in powdered form, blended, and formulated into a dry oral dosage form such as a pill, capsule, chewable tablet, gel cap, or caplet.

A method of preventing or reducing the occurrence of urinary tract infections according to the present disclosure comprises administering to an adult human approximately 9500 mg per day, every day, of the formulation described above. The formulation is preferably in the form of two dosage units (ie. tablets), wherein each unit includes about 750 mg vitamin C, about 2000 mg D-mannose powder, about 1000 mg cranberry extract, and about 1000 mg pineapple extract. Both dosage units may be taken together, or one dosage unit may be taken twice a day. Alternatively, the method may comprise comprises administering to a human child approximately 4750 mg per day of the same formulation.

When taken daily at the dosages described above, the formulation will lower the pH of the patient's urine, thereby suppressing bacterial growth, improving urine odor, and preventing or reducing the frequency of urinary tract infections.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A formulation comprising the following components, in combination with acceptable excipients or additives:
vitamin C;
D-mannose powder;
cranberry extract; and
pineapple extract.

2. An oral dosage unit comprising the formulation of claim 1.

3. The formulation of claim 1, having the following composition:
about 750 mg vitamin C;
about 2000 mg D-mannose powder;
about 1000 mg cranberry extract; and
about 1000 mg pineapple extract.

4. A prophylaxis for preventing or reducing the occurrence of urinary tract infections, comprising:
an oral dosage unit including therapeutically effective amounts of vitamin C, D-mannose powder, cranberry extract, pineapple extract, and acceptable additives and excipient.

5. The prophylaxis of claim 4, wherein the oral dosage unit is formulated as a dry delivery system.

6. The prophylaxis of claim 5, wherein the oral dosage form is selected from the group consisting of pills, capsules, gel caps, tablets, and caplets.

7. The formulation of claim 4, having the following composition:
about 750 mg vitamin C;
about 2000 mg D-mannose powder;
about 1000 mg cranberry extract; and
about 1000 mg pineapple extract.

8. A method of preventing or reducing the occurrence of urinary tract infections, comprising administering to a subject a formulation comprising, in combination with acceptable additives and excipients:
vitamin C;
D-mannose powder;
cranberry extract; and
pineapple extract.

9. The method according to claim 8, wherein the formulation is administered in an oral dosage form.

10. The method according to claim 9, wherein the formulation is administered in a dry delivery form.

11. The method according to claim 10, wherein the formulation is administered in a dosage form selected from the group consisting of capsules, tablets, and caplets.

12. The method according to claim 8, wherein the formulation has the following composition:
about 750 mg vitamin C;
about 2000 mg D-mannose powder;
about 1000 mg cranberry extract; and
about 1000 mg pineapple extract.

13. The method according to claim 8, wherein:
the subject is an adult human; and
administering the formulation comprises administering about 9500 mg per day on a daily basis.

14. The method according to claim 8, wherein:
the subject is a human child; and
administering the formulation comprises administering about 4750 mg per day, every day.
